(19) United States
(12) Patent Application Publication
(10) Pub. No.: US 2018/0159632 A1
(43) Pub. Date: Jun. 7, 2018

(54) APPARATUS FOR TRANSMITTING SIGNALS BASED ON REFLECTIONS AND RELATED METHOD

(71) Applicant: POLITECNICO DI MILANO, Milano (IL)

(72) Inventors: Umberto SPAGNOLINI, Milano (IT); Mario MARTINELLI, San Donato Milanese (MI) (IT)

(21) Appl. No.: 15/575,074

(22) PCT Filed: May 18, 2015
(86) PCT No.: PCT/EP2015/060854

§ 371 Date: Nov. 17, 2017

(51) Int. Cl. H04B 10/54; H04B 10/112; H04L 27/04

(52) U.S. Cl. CPC H04B 10/541; H04B 10/1123; H04L 25/4917; H04B 2210/006; H04L 27/04

(57) ABSTRACT

It is described a transmitter of signals, comprising: an encoder (1) configured to generate a two-state modulation signal (x_{D}(t)) from a first input signal (x(t)), means (2) configured to act on a second input signal (y(t)) as a function of the two-state modulation signal; the means are configured to reflect the second input signal from the transmitter in correspondence of only one state (ON) of two states (ON, OFF) of the two-state modulation signal.

The present invention refers to an apparatus for transmitting signals based on reflections and related method.

In the known equipments for signal transmission and reception the signals are transmitted according a certain modulation from the transmitter and are demodulated by the receiver. A typical signal modulation is, for example, the pulse amplitude modulation, other is pulse width modulation or PWM.

In future 5G cellular communication systems the antennas of the radio access (RA) network are further densified and centrally controlled by multiple and programmable base-band units (BBUs). Multiple BBUs are hosted in the same place with large benefits in term of scalability and programmability, while their antennas are the remote units (RU) that serve mobile devices and are characterized by a minimal local processing and some radiofrequency circuits. Connection between BBUs and RUs is referred in technical jargon as front-hauling and it transports the RU-to-BBU (upstream) and BBU-to-RU (downstream) signals over a radio link, or optical fiber, or cable, or any combination depending on the pre-existing or newly deployed infrastructures. The centralized BBU architecture in figure has the capability to keep all the RUs synchronized to the timings distributed by the BBUs over the downstream, and this eases the cooperation among the RUs according to the so called Cooperative Multipoint (CoMP), Cloud-RadioAccess (C-RAN), massive MIMO architectures for 5G systems.

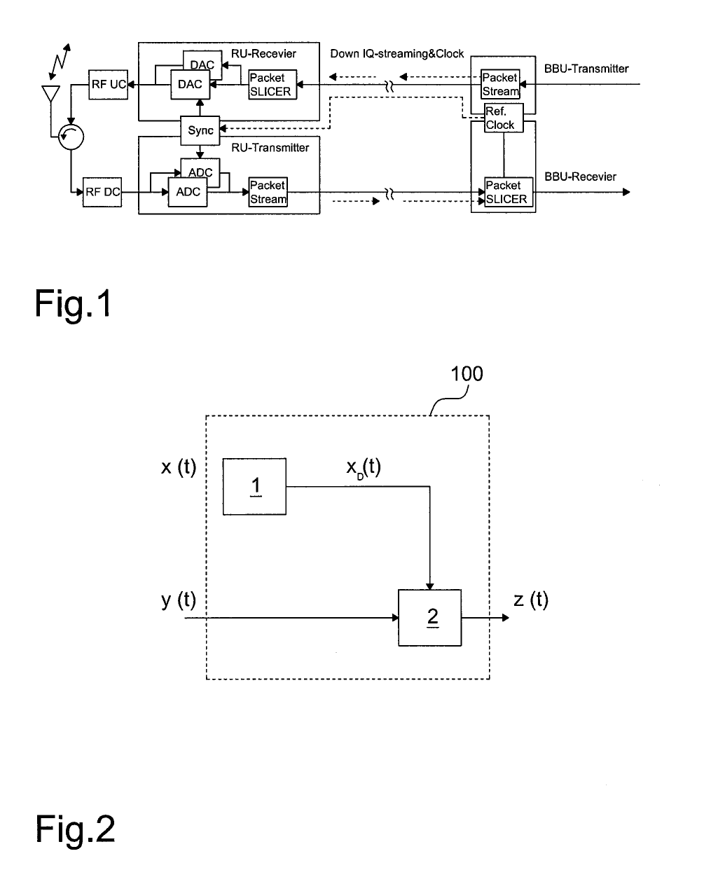

In prior-art described in FIG. 1, at RU the radiofrequency signal (typically 0.9 GHz or 1.8 GHz, or 2.4 GHz, or slightly higher depending on the radio access protocol) from mobile devices is down-converted by means of the block RF-DC to a lower frequency and in-phase and quadrature (IQ) signals are digitized with analog-digital converter ADC operating at least at double sampling frequency and transmitted to the BBU as bit stream, similarly for the signals to be transmitted to the mobile device from the BBU through the RU. The upstream and downstream connections between RU and BB (shown in FIG. 1 as Up IQ-streaming from RU to BBU, and as Down IQ-streaming from BBU to RU) are based on the exchange of the IQ digitized streams of radiofrequency signals after being digitized and arranged into a sequence of packets by means of the block Packet Stream in the RU-Transmitter according to any of the available protocols routinely adopted within the industry such as CPRI (Common Public Radio Interface) or OBSAI (Open Base Station Architecture Initiative) or any other similar protocol that exchanges the digital streams digitized at the RU before being forwarded to the BBU-receiver in upstream, particularly to the block Packet Slicer. Dually at downstream, the RU-Receiver, particularly the block Packet Slicer, receives the digital IQ stream arranged into sequenced packets by the block Packet Stream of the BBU-Transmitter toward the RU that locally converts the digital IQ stream into a analog signal by digital-analog converter DAC before being up-converted by means of the block RF-UC into RF signals to be radiated by an antenna at RU. In the sketch of the prior-art for the remotization system illustrated in FIG. 1 there is the timing embedded into the IQ downstream (from BBU to RU) that eases the timing of the digital samples, but not necessarily of the single RU due to some circuitry latency (e.g., packet slicers or framers). A clock signal Clock is generated at BBU by the block Ref. Clock and the signal Clock is sent to the block Sync of the RU for the synchronization of the block ADC and DAC of the RU, and other synchronization issues such as signals' alignment and timing advance.

Prior-art structures make the ADC and DAC at the RU with an unavoidable bandwidth expansion due to the digitalization of the IQ streaming rather then transmitting the analog signals. This bandwidth expansion can be intolerably high when the number of RUs to be connected over the serial IQ streaming connection increases. Attempts to mitigate this excess of bandwidth of signals' digitalization is by employing compressions algorithms at the RU (in upstream) or at the BBU (in downstream), but solutions are still uneffective. The numerical example below for upstream clarifies the limitations of the prior-art solved by this patent, the same example can be trivially made for downstream. The transmitters for analog signals are based on ADC that transforms the analog signal into a pair of digital IQ streams that in turn are transmitted after modulating appropriate signals. However, the main limitation is due to the bandwidth expansion of the ADC as every analog signal with bandwidth B is sampled at least at frequency 2B, and every sample is quantized into N bits/sample where the choice of N bits depends on the quantization noise that is tolerated by the application. As example, for a radiofrequency signal with bandwidth B=100 MHz, and signal-to-quantization noise larger that 45 dB, it is necessary at least N=8 bit/sample that in turn makes the bit-rate of the front-hauling 2BN=1.6 Gbit/sec; overall it is a bandwidth expansion of ×16 as minimum. In CPRI protocol the expansion can be as high as ×30, and CPRI compression as in patent U.S. Pat. No. 8,331,461 can reduce the expansion as low as ×16-18.

Another prior art for encoding the information based on the backscattering principle is the Radio-frequency identification (RFID) technology. The RFID is used to identify and track tags attached to objects by an interrogation procedure. The reader sends a radio-frequency signal to the tag that backscatter part of the radio-frequency signal in response, according to the information stored in the tag. RFID tags can be either passive, active or battery-assisted passive but in any case the information is the result of a backscattering procedure where part of the impinging energy is returned back to the reader in form of tag-identification. Since tags have individual identifiers such as serial numbers, the RFID system can discriminate among several tags that might be within the range of the RFID reader and read them simultaneously.

In view of the state of the art, it is an object of the present invention to provide an apparatus for transmitting signals based on reflections which is different from prior art.

According to the present invention, said object is achieved by means of a transmitter of signals, comprising:

a encoder configured to generate a two-state modulation signal from a first input signal,

means configured to act on a second input signal as a function of the two-state modulation signal, characterized in that said means are configured to reflect said second input signal in correspondence of only one state of the two states of the two-state modulation signal.

Preferably said encoder is a duty-cycle encoder and said means are configured to reflect said second input signal for the duration of said one state of two states of the two-state modulation signal.

Also according to the present invention, it is possible to provide a signal transmission and reception apparatus as defined in claim 10.

Moreover according to the present invention, it is possible to provide a method for transmitting signal as defined in claim 14.

As prior-art, patents US2007/0075886; EP2557703A1; EP1715586A2; CN1941675; EP2575309 are all considering the principle of duty-cycle communication with active optical source (laser or led) but without the concept of reflecting the probing signal represented by the light originated elsewhere such as from the receiver itself.

The advantage of this invention is that the digitization of the signal at the RU can be avoided, and in any case it is not necessary for communication to the BBU since the sampled signal is encoded using its full bandwidth without any bandwidth expansion due to digitizing. Prior-art in this field are the patents U.S. Pat. No. 5,339,184A and U.S. Pat. No. 5,682,256A that belong to the radio-over-fiber (RoF) method where the radio signal is used to modulate the intensity of the light over a fiber. Patent EP2540134 proposes to use the radiofrequency signal to modulate the signal over a twisted-pair. However, none use the duty-cycle encoding paired with passive reflections as means for transmission.

Another advantage of this invention is the full control of the transmission (from RU) carried out from the receiver (central unit) in term of timings, transmission times, signaling for duplexing so that it centralizes the use of the RUs. This guarantees a perfect mutual synchronization of all the RUs (up to a fraction of digitization interval) so as to let them act as a compound distributed array of antennas with all the known benefits.

Further advantage is the flexibility of the reflector of the transmitter that is not assembled to comply with one specific narrowband signal, but rather to reflect a probing signal that in turn might have frequency or wavenumber set by the receiver. In optical systems this means that the reflector-based transmitter is not a laser system tuned to one wavelength but rather the transmitter flexibly adapts to the wavelength of the probing signal originated from another device such as the receiver itself with remarkable complexity reduction.

Benefit is the passive action of the reflector that does not actively generate the transmission signal, say from RU to Central BBU unit. There are several engineering benefits from the usage of these passive devices at transmitter rather than conventional active devices ranging from energy efficiency (any transmitter can be turned on/off by controlling the probing signal), simplicity (passive device is far more simple that an active one), flexibility (the device is not tailored on one specific radio protocol or signal but it can be used in any setting) and scalability (there is no limit to the number of passive reflecting devices to be controlled from the receiver with probing signals, or the signals to be aggregated to be transmitted using the passive reflections).

The invention of the patent application is different from the analog-to-digital converter based on duty-cycle modulation as in the scientific publication by E.Roza, “Analog-to-Digital Conversion via Duty-Cycle Modulation”, IEEE Trans. Circuit and System II: Analog and Digital Signal Processing, vol.44, n.11, pp.907-914; for the following aspects:

transmitter makes no digital conversion or quantization but rather encodes the duty-cycle signal over the communication medium as another two-states analog-signal;

transmitter encodes the two-state analog-signal by reflecting another signal generated externally to the transmitter, possibly from the receiver itself.

To further distinguish with respect to the state of the art, backscattering principle is different from RFID-tags reflection. Even if the role of the receiver in the interrogation of the transmitter and the transmitter in backscattering the signal can evoke an RFID-tag technology, this patent is different from the backscattering in an RFID-tag and variations (US2012/0309295A1) as:

there is no interrogation, the reference is transmitting continuously a probing signal not coordinated with others, and the transmitter is not activated by the energy received from the probing signal;

transmitter sample periodically an analog signal external to the transmitter and duty-cycle encoder (DCE) maps the amplitudes into a duty-cycle signal that in turn controls the backscattering device;

transmitter backscatters probing signal originated as voltage from a cable connection, a RF signal from an antenna, the light from an optical-fiber, and extension from the architecture of an RFID is not obvious.

For a better understanding of the present invention, some embodiments thereof are now described, purely by way of non-limiting examples and with reference to the annexed drawings, wherein:

FIG. 1 is a schematic view of an apparatus for transmitting and receiving signals according to prior art;

FIG. 2 is a schematic view of a transmitter of signals based on reflections according to the present invention;

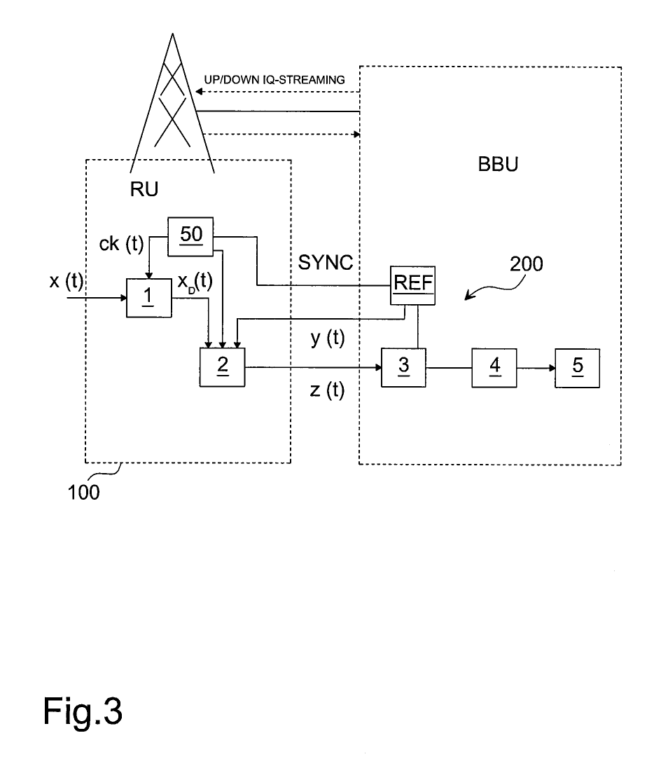

FIG. 3 is a schematic view of an apparatus for transmitting and receiving signals which comprises the transmitter in FIG. 1 according to a first embodiment of the present invention;

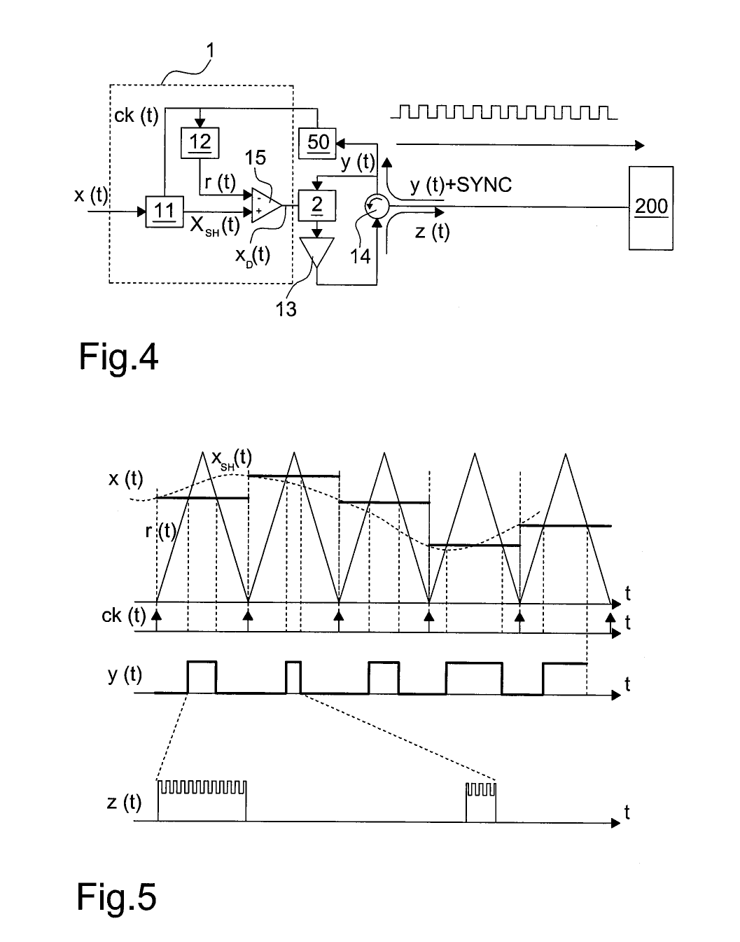

FIG. 4 is a more detailed view of the transmitter in FIG. 1;

FIG. 5 is a time diagram of some of the signal in play in the transmitter of FIG. 3;

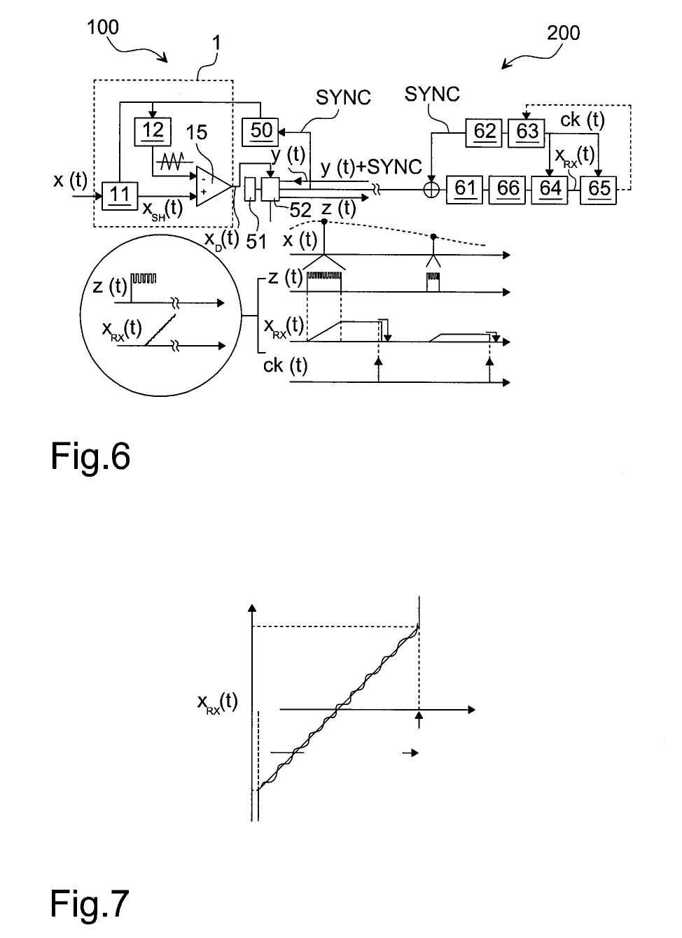

FIG. 6 is a schematic view of an apparatus for transmitting and receiving signal which comprises the transmitter in FIG. 2 according to a second embodiment of the present invention;

FIG. 7 shows the influence of the synchronism signal on the backscattering signal of the receiver of a known transmission and reception apparatus;

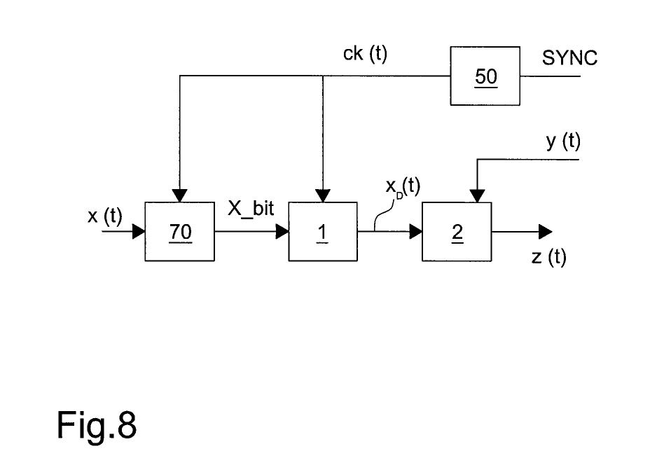

FIG. 8 is a schematic view of a transmitter of signal according to a variant of the first embodiment of the present invention.

With reference to FIG. 2 a transmitter 100 of signals, that is electromagnetic or optical signals, based on reflections according to the present invention is described.

The transmitter 100 comprises an encoder 1, preferably a duty-cycle encoder, configured to generate a two-state modulation signal x_{D}(t), particularly the two states ON and OFF, from a first input signal x(t).

The transmitter comprises means 2 configured to reflect a second input signal y(t) as a function of two-state modulation signal x_{D}(t); particularly, the reflecting means 2 are configured to reflect the second input signal y(t) from the transmitter 100 at the correspondence of only one state ON of the two states ON, OFF of the two-state modulation signal x_{D}(t) so as to output a reflected signal z(t) from the transmitter 100. The second input signal y(t) may be an analog signal, preferably a radiofrequency signal, or an optical signal; preferably, in the case of analog or optical input signal, the reflecting means 2 are configured to reflect the second input signal y(t) for the whole duration of the state ON of the two-state modulation signal x_{D}(t).

During the state ON, the reflected signal z(t) has possibly the same frequency or wavelength of the signal y(t), and possibly with comparable amplitude or power except some minor absorption related to the technical capability of the device, or even larger amplitude than the amplitude of the signal y(t) if the reflecting means 2 have amplification capabilities. The absorption-state, that is the state OFF, is when the signal y(t) is not reflected, or when only a minor quantity is reflected, say smaller than 1/10 or even smaller than 1/100 of the power of the signal y(t) when in ON state.

The reflector 2 controlled by the two-state modulation signal x_{D}(t) is specifically designed to make for z(t) a copy of the signal y(t) upon all the duration of the state ON, and to disable any reflections on the state OFF except minor leakage that can due to the imperfections of the isolation. Reflector 2 can include any processing that is instrumental to avoid self-interference and self-oscillation such as a predefined frequency translation between the output z(t) and the signal y(t), an amplification, a predefined change of polarization, or any combination of these.

An example of reflecting means for radiofrequency signals as further detailed in FIG. 3 contains a switch on the signal y(t) controlled by the two-state modulation signal x_{D}(t) that, on the OFF state, disable any further connection, while on ON state the signal y(t) is electrically connected to a multiplier that translates the frequency of y(t) according to the reference periodic signal extracted from the timing block 50 connected to the synchronization signal SYNC.

Another example of reflecting means is an electrically controllable mirror or an optical device as a semiconductor optical amplifier (SOA) and a mirror. Another example of reflecting means is the backscattering of the impinging radiofrequency signal as for RFID.

The input signal x(t) may be an analog signal, a digital signal or an optical signal.

With reference to FIG. 3, an electromagnetic signal transmission and reception apparatus is described wherein the transmitter 100 is disclosed in FIG. 2 and the receiver is configured to receive the signal z(t). Preferably the input signal y(t) of the transmitter 100 is sent from the receiver 200; the signal y(t), which is a probing signal, is derived from a device REF of the receiver 200 which outputs reference signals.

The receiver 200 is equipped with a coupler 3 that has the capability to decouple the signal y(t) generated by the device REF from the reflected signal z(t) containing the modulated information from the transmitter 100 in term of reflect/no-reflect information with appropriate duty-cycle that maps onto the reflect/no-reflect durations. A duty-cycle decoder or DCD 4 resumes the original information that can be either digitally converted by means of an analog-to-digital converter or ADC 5, or used as it is after some filtering to recover the analog signal from the samples according to the duration of the states ON or of its duty-cycle.

An application of the electromagnetic signal transmission and reception apparatus according to the present invention is for radio access in mobile phone networks. The upstream and downstream connections between RU and BB are indicated as Up IQ-streaming from RU to BBU and as Down IQ-streaming from BBU to RU and are based on the exchange of the IQ digitized streams of the radiofrequency signals; the transmitter 100 belonging to the RU while the receiver 200 belonging to the BBU.

The transmitter 100 is described in more detail in FIG. 4 in the case of a radiofrequency wireless application. The analog signal x(t) at time t is input to the duty-cycle encoder or DCE 1 that encodes the amplitude of the analog signal onto the two-state signal x_{D}(t) of states ON and OFF using a monotonic mapping function τ (x) of the input amplitude. Particularly, the DCE 1 has at the input a clock signal ck(t) preferably deriving from a clock generator 50 belonging to the transmitter 100 and having at the input the synchronization signal SYNC deriving from the receiver 200; the DCE 1, using the monotonic mapping function r (x), periodically sample and maps the instantaneous amplitude x(t) onto a two-state signal x_{D}(t) with the states ON and OFF and wherein the duration of the state ON is proportional to the value x(t). The two-state signal x_{D}(t) controls the reflecting means 2; particularly in the state ON of the two-state signal x_{D}(t) the reflecting means 2 reflect the signal y(t) undistorted, preferably amplified by an amplifier 13 and preferably altered in some other characteristics such as polarization, frequency, wavelength just to exemplify, for the whole duration of the state ON while in the state OFF of the two-state signal x_{D}(t) the reflecting means absorb the signal y(t). The reflecting means 2 have the capability to reflect the probing signal y(t) as a function of the state of the two-state signal)(x_{D}(t); the reflecting means 2 act as a switch controlled by the DCE 1 signals for the signal y(t). The peculiarity is that the transmitter 100 has no capability to autonomously and locally generate the signal used for the transmission but only to reflect to some degree the probing signal y(t) depending on the two-state signal x_{D}(t) that encodes the analog signal x(t) in term of duty-cycle.

Preferably the input signal y(t) of the transmitter is generated at the receiver 200 by means of the device REF, or any device different from the transmitter 100, for example as non-modulated signal with some periodic signal SYNC for synchronization of the transmitter 100.

Duty-cycle information is related to the accuracy of the rising (or positive) and falling (or negative) edges as any error in edges due to noise or timing is interpreted at receiver as a duty-cycle and thus as an amplitude of the analog signal. Jitter can be controlled centrally at the receiver 200 that sends the signal y(t) by adding a synchronization signal SYNC, superimposed to the signal y(t), that does not impairs the functionalities of the reflection-based modulation and which is reflected back from the reflecting means 2 during the state ON of the two-state signal x_{D}(t). The signal SYNC derived from the device REF belonging to the receiver 200 has several additional practical benefits such as it is used to estimate the RU-BBU propagation delay, to enable multiple RUs to operate synchronously by aligning the time-offsets, or in general to estimate the distance between receiver 200 and transmitter 100. Furthermore, the superimposed synchronization signal SYNC enables the transmitter 100 to extract the reference timing for the transmitter synchronization of the transmitter 100 to the receiver 200 and for the clock generator 50 that extracts the signals of the DCE 1.

As shown in FIG. 4, the analog signal x(t) is sent to the DCE 1 including a sample and hold device 11 adapted to sample the signal x(t) at the sample times established by the clock signal ck(t) deriving from the clock generator 50 having at the input the synchronization signal SYNC; the sample and hold device 11 outputs an analog signal x_{SH}(t) with the same amplitude of the instantaneous analog-signal x(t). The DCE 1 comprises also a sawtooth generator 12 that is configured to generate a periodic and symmetric triangular waveform r(t) (shown in FIG. 5) that is synchronized with the sample and hold device 11 and is controlled by the clock signal ck(t). The DCE 1 comprises a comparator 15 configured to compare the analog signal x_{SH}(t) (at the non-inverting input terminal of the comparator) and the periodic and symmetric triangular waveform r(t) (at the inverting input terminal of the comparator); the duration of the state ON of the output signal, that is the two-state signal x_{D}(t), depends on the amplitude of the analog signal x_{SH}(t).

The reflecting means 2, controlled by the two-state signal x_{D}(t), act as a switch that reflects or not the signal y(t) as function of the state of the two-state signal x_{D}(t). Preferably, to compensate the attenuation from transmitter 100 to receiver 200, the signal y(t) can be amplified and/or frequency shifted by means of a device 13 before being retransmitted back. A decoupling device 14 such as a circulator, known in the state of the art, decouples the signal y(t) transmitted from the receiver to the transmitter from the signal z(t) generated at the transmitter 100 and transmitted back to the receiver.

According to a second embodiment of the present invention, FIG. 6 shows a transmission and reception apparatus of signals for optical fiber.

The transmitter 100 is similar to the transmitter 100 in FIG. 5 except for the reflecting means 2 that comprise an optical mirror 51 that is electrically controlled by the two-state signal x_{D}(t) deriving from the DCE 1 by a comparator configured to compare the analog signal x_{SH}(t) (at the non-inverting input terminal of the comparator) and the periodic and symmetric triangular waveform r(t) (at the inverting input terminal of the comparator). Preferably the two-state signal x_{D}(t) controls the gain of an amplifier 52, preferably a semiconductor optical amplifier or SOA, and the optical mirror 51, preferably a Faraday rotator mirror; the SOA 52 allows the passage of the optical signal y(t) toward the mirror in the state ON of the two-state signal x_{D}(t) and prevents the passage of the optical signal y(t) toward the mirror in the state OFF of the two-state signal x_{D}(t).

The receiver 200 comprises a photodiode 61 configured to receive the optical signals reflected by the optical mirror 51. The device REF in this case comprises a master clock 62 configured to generate the signal SYNC and a phase shifter 63 controlling a duty-cycle decoder by means of the clock signal ck(t). Preferably the duty-cycle decoder comprises an integrate-and-dump block 64, controlled by the phase shifter 63, that integrates the received signal and a sample and hold 65, controlled by the phase shifter 63, that samples the integrated signal x_{RX}(t) before being dumped.

Preferably the receiver 200 comprises even a saturation device 66 configured to avoid the fluctuations of the amplitude induced by the synchronization signal SYNC superimposed to the signal y(t) for the sake of synchronizing the transmitter to the receiver timings.

FIG. 7 illustrates the influences of the synchronization signal SYNC on the signal y(t). The presence of the synchronization signal leaves a residual fluctuation on the signal z(t) and also downstream the duty-cycle encoder 1 that causes errors in the amplitude/duty-cycle mapping in the DCD of the receiver; the saturation device 66 represents one method for removing the DCD artifacts illustrated in FIG. 7. Alternatively, the fluctuations can be compensated after mapping the amplitude to time by a preliminary calibration procedure by transmitting a set of known analog-values and creating a look-up table for the corrections at the receiver. The calibration procedure can be repeated periodically if artifacts might change in time.

The transmitter 100 can be configured to accept digital signal x_bit as shown in FIG. 8. The DCE 1 accepts the encoded bits x_bit that represent the information to be transmitted and in turn generates the states ON/OFF to control the reflecting means 2 for the reflection of the signal y(t) according to a predefined duty-cycle mapping that maps the encoded bits x_bit onto a state ON of appropriate duty-cycle of the two states ON/OFF. The mapping is embedded into the DCE 1 as a look-up table or any other duty-cycle mapping device that accept bits x_bit and outputs the two-state signal x_{D}(t). To exemplify, the encoded bits x_bit can be stored in a local memory unit or buffer at transmitter 100 for transferring to the receiver. As an alternative solution the transmitter 100 can include an ADC stage 70 of the analog input signal x(t), as shown in FIG. 8 according to a variant of the first or the second embodiment of the present invention.

As a further alternative, the set of encoded bits of x_bit are each individually encoding the ON/OFF states to control the reflecting means 2 for the reflection of the signal y(t) without the duty-cycle mapping by the DCE, and the reflected signal z(t) has the same duration for every state ON.

1. Transmitter of signals, comprising:
an encoder (1) configured to generate a two-state modulation signal (x_{D}(t)) from a first input signal (x(t)),
means (2) configured to act on a second input signal (y(t)) as a function of the two-state modulation signal, characterized in that said means are configured to reflect (z(t)) said second input signal in correspondence of only one state (ON) of the two states (ON, OFF) of the two-state modulation signal.

2. Transmitter according to claim 1, characterized in that said encoder (1) is a duty-cycle encoder and said means (2) are configured to reflect said second input signal (y(t)) for the duration of said one state (ON) of the two states (ON, OFF) of the two-state modulation signal.

3. Transmitter according to claim 2, characterized in that in the case wherein the first input signal is an analog signal (x(t)), the duty-cycle encoder (1) encodes the amplitude of said analog signal onto the two-state modulation signal (x_{D}(t)).

4. Transmitter according to claim 3, characterized in that the transmitter has an input clock signal (ck(t)), said duty-cycle encoder (1) has at the input the input clock signal (ck(t)) and periodically sample and maps the instantaneous amplitude of the analog signal (x(t)) onto said two-state modulation signal (x_{D}(t)) and wherein the duration of said one state (ON) of the two states (ON, OFF) of the two-state modulation signal is proportional to the value of the analog signal (x(t)).

5. Transmitter according to claim 4, characterized by comprising a sample and hold device (11) adapted to sample the analog signal x(t) at the sample times established by the clock signal (ck(t)) and to output a further signal (x_{SH}(t)) with the same amplitude of the analog-signal x(t), a sawtooth generator (12) adapted to generate a periodic and symmetric triangular waveform (r(t)) that is synchronized with the sample and hold device (11), a comparator (15) configured to compare the further signal (x_{SH}(t)) and the periodic and symmetric triangular waveform (r(t)) and to output said two-state modulation signal (x_{D}(t)) wherein the duration of said one state (ON) of the two states (ON, OFF) of the two-state modulation signal depends on the amplitude of the further signal (x_{SH}(t)).

6. Transmitter according to claim 1, characterized in that in the case wherein the first input signal is a digital signal (x_bit), the encoder (1) encodes the value of said digital signal onto the two-state modulation signal (x_{D}(t)).

7. Transmitter according to claim 1, characterized in that said reflecting means comprise an optical mirror and the second input signal (y(t)) is an optical signal.

8. Transmitter according to claim 7, characterized in that said reflecting means (2) comprise an optical amplifier (52), said two-state modulation signal (x_{D}(t)) controlling the gain of said optical amplifier (52) to allow the passage of the optical signal (y(t)) toward the optical mirror in said one state (ON) of the two states (ON, OFF) of the two-state modulation signal (x_{D}(t)) and prevents the passage of the optical signal (y(t) toward the mirror in said other state (OFF) of the two states (ON, OFF) of the two-state modulation signal.

9. Transmission and reception apparatus of signals comprising a transmitter (100) as defined in claim 1 and a receiver (200) configured to generate the second input signal (y(t)) of the transmitter and receive the reflected signal (z(t)) at the output of the transmitter.

10. Apparatus according to claim 9, characterized in that said receiver comprises a generator (REF) of a synchronization signal (SYNC), said synchronization signal (SYNC) being sent to the transmitter superimposed to the second input signal (y(t)) for the formation of the clock signal.

11. Apparatus according to claim 9, characterized in that said receiver comprises a generator (REF) of a synchronization signal (SYNC), said synchronization signal (SYNC) being sent to the transmitter superimposed to the second input signal (y(t)) for the synchronization of the transmitter and the receiver.

12. Apparatus according to claim 10, characterized in that the receiver (200) comprises even a saturation device (66) configured to avoid the fluctuations induced by the synchronization signal (SYNC) superimposed to the second input signal (y(t)) for the sake of synchronizing the transmitter to the receiver timings.

13. Apparatus according to claim 9, characterized in that said transmitter (100) comprises further means (14) configured to decouple the reflected signal (z(t)) at the output from the transmitter and at the input of the receiver and the second input signal of the transmitter.

14. Method for transmitting signals, comprising:
generating a two-state modulation signal (x_{D}(t)) from a first input signal (x(t)),
acting on a second input signal (y(t)) as a function of the two-state modulation signal, characterized by comprising reflecting said second input signal in correspondence of only one state (ON) of the two states (ON, OFF) of the two-state modulation signal.

15. Method according to claim 14, characterized in that said reflecting step comprises reflecting said second input signal (y(t)) for the duration of said one state (ON) of the two states (ON, OFF) of the two-state modulation signal.

16. Method according to claim 14, characterized in that the first input signal is an analog signal and by comprising periodically sampling and mapping the instantaneous amplitude of the analog signal (x(t)) onto said two-state modulation signal (x_{D}(t)) and wherein the duration of said one state (ON) of the two states (ON, OFF) of the two-state modulation signal is proportional to the value of the analog signal (x(t)).

17. Method according to claim 16, characterized by comprising sampling the analog signal x(t) at the sample times established by an input clock signal (ck(t)), generating a further signal (x_{SH}(t)) with the same amplitude of the analog-signal x(t), generating a periodic and symmetric triangular waveform (r(t)) that is synchronized with the sampling step, comparing the further signal (x_{SH}(t)) and the periodic and symmetric triangular waveform (r(t)) and to output said two-state modulation signal (x_{D}(t)) wherein the duration of said one state (ON) of the two states (ON, OFF) of the two-state modulation signal depends on the amplitude of the further signal (x_{SH}(t)).

18. Method according to claim 14, characterized in that the first input signal is a digital signal (x_bit) and by comprising encoding the value of said digital signal onto the two-state modulation signal (x_{D}(t)) and by comprising periodically mapping the value of said digital signal (x_bit) onto said two-state modulation signal (x_{D}(t)) and wherein the duration of said one state (ON) of the two states (ON, OFF) of the two-state modulation signal is derived from the digital signal (x_bit).

19. Method according to claim 14, characterized in that the first input signal is a digital signal (x_bit) and by comprising encoding the value of said digital signal onto the two-state modulation signal (x_{D}(t)).
